(19) United States
(12) Patent Application Publication
(10) Pub. No.: US 2025/0273453 A1
(43) Pub. Date: Aug. 28, 2025

(54) Detection Saturation Correction and De-Coalescence by Ion Beam Modulation

(71) Applicant: DH Technologies Development Pte. Ltd., Singapore (SG)

(72) Inventors: Nicholas G. BLOOMFIELD, Newmarket (CA); Pavel RYUMIN, Toronto (CA); Gordana IVOSEV, Etobicoke (CA)

(73) Assignee: DH Technologies Development Pte. Ltd., Singapore (SG)

(21) Appl. No.: 18/857,662

(22) PCT Filed: Apr. 25, 2023
(86) PCT No.: PCT/IB2023/054221

§ 371 Date: Oct. 17, 2024

Related U.S. Application Data
(60) Provisional application No. 63/334,304, filed on Apr. 25, 2022.

(51) Int. Cl. H01J 49/06; H01J 49/00; H01J 49/02

(52) U.S. Cl. CPC H01J 49/065; H01J 49/0027; H01J 49/022; H01J 49/025

(57) ABSTRACT

In one aspect, a mass spectrometer is disclosed, which comprises an ion source configured to receive a sample and ionize at least one analyte in the sample to generate a plurality of analyte ions, and at least a first ion routing device having a first inlet for receiving at least a portion of the plurality of the analyte ions and at least a first and a second outlet through which a first and a second portion of the received analyte ions can exit the ion-routing device, respectively. The mass spectrometer can further include at least two charge reduction devices one of which is coupled via a first inlet thereof to the first outlet and the other is coupled via an inlet thereof to the second outlet of the ion routing device to receive said first and second portions of the ions exiting the ion routing device.

### RELATED APPLICATIONS

This application claims priority to U.S. provisional application No. 63/334,304 filed on Apr. 25, 2022, entitled “Detection Saturation Correction and De-Coalescence by Ion Beam Modulation,” which is incorporated herein by reference in its entirety.

### TECHNICAL FIELD

The present teachings are generally related to systems and methods for mass spectrometry, and more particularly to such systems and methods that can be employed to resolve coalesced mass peaks and to obtain accurate information for such mass peaks.

### BACKGROUND

Mass spectrometry (MS) is an analytical technique for determining the elemental composition of test substances with both qualitative and quantitative applications. MS can be useful for identifying unknown compounds, determining the isotopic composition of elements in a molecule, determining the structure of a particular compound by observing its fragmentation, and quantifying the amount of a particular compound in a sample. Mass spectrometers detect chemical entities as ions such that a conversion of the analytes to charged ions must occur during the sampling process.

Analogue ion detection systems typically employed in mass spectrometers exhibit a signal response that is generally governed by the instrument resolution and is wider than the intrinsic width of the distribution of the detected ions. To preserve high mass resolution, analogue signals are typically analyzed in real time and the centroid time and the respective mass peak intensity, which correspond, respectively, to average ion arrival time and the number of coincidental ions, are recorded. When isotopes of a single compound or those of multiple compounds are closely spaced in mass, a detector response can be analyzed in real time to detect the presence of multiple coalesced analogue signal peaks, that is, to achieve de-coalescence of the coalesced mass peaks.

The conventional methods for achieving such de-coalescence present certain limitations. For example, the overlap of the mass peaks (i.e., the coalescence of the mass peaks) may result in unresolvable, wide analogue signal peaks, for example, in cases where mass peaks associated with isotopes of highly charged ions overlap. The difficulty in resolving the mass peaks can, in turn, render the accurate inference of the underlying ion distribution and peak mass intensity impractical. Further, when the concurrent incidence of multiple ions on an ion detector leads to the generation of a saturated ion signal, only overall underlying ion intensity can be predicted via saturation correction, but not whether the signal is associated with a single or multiple underlying ion distributions

### SUMMARY

In one aspect, a method of operating a mass spectrometer is disclosed, which comprises acquiring a first mass spectrum of a first portion of plurality of ions at a first ion beam intensity, acquiring a second mass spectrum of a second portion of said plurality of ions at a second ion beam intensity lower than the first ion beam intensity, and using the second mass spectrum to interpret at least one mass peak comprising two or more coalesced mass peaks, if any, in the first mass spectrum.

The interpretation of the at least one mass peak comprising two or more coalesced mass peaks can include determining a peak intensity and an m/z ratio associated with each of said two or more coalesced mass peaks.

In some embodiments, a third mass spectrum can be optionally generated in which each of the coalesced mass peaks is identified based on the peak intensity and the m/z ratio determined for that coalesced mass peak using the second mass spectrum.

In some embodiments, one of said two different ion beam intensities corresponds to a maximum of the ion beam intensity modulation and the other one of said two different ion beam intensities corresponds to a minimum of the ion beam intensity modulation.

In some embodiments, the method can include modulating an intensity of the ion beam to generate an intensity-modulated ion beam such that said first and said second ion beam intensities correspond to different ion beam intensities during a cycle of the ion beam intensity modulation.

In some embodiments, no active modulation of the ion beam intensity may be employed. Rather, the ion detection signals can be processed after acquisition to determine whether the data exhibits a modulation of the ion signal intensity. The information regarding the modulation of the ion signal intensity, if any, can then be employed to process the mass data so as to generate at least two mass spectra each corresponding to a different ion signal intensity. The mass spectra can then be utilized, e.g., in a manner discussed herein, to achieve deconvolution of one or more coalesced mass peaks if any identified in at least one of the spectra.

The ratio of the maximum intensity of an intensity modulated ion beam relative to the minimum intensity thereof can be in a range of about 2 to about 20, for example, in a range of about 5 to about 15.

In many embodiments, the lower ion beam intensity can be selected so as to reduce the the probability of ion coalescence.

The coalesced mass peaks can occur, for example, due to the detection of two or more ion signals corresponding to two or more ions having sufficiently close m/z ratios that are not fully resolvable by the mass spectrometer. By way of example, and without limitation, in some cases, such coalesced mass peaks can be associated with two or more different isotopes of an analyte.

The methods according to the present teachings can be implemented in a variety of mass spectrometers using various mass analyzers. By way of example, in some embodiments, the mass spectra can be acquired using a time-of-flight (Tof) mass analyzer.

In some embodiments, the ion beam intensity modulation can be performed without a substantial loss of ions in the ion beam. In other embodiments, the ion beam intensity modulation can be achieved via periodic removal of ions from the ion beam.

In some embodiments, the modulation of the ion beam intensity can be achieved by bunching ions in the ion beam to generate a plurality of ion packets that are temporally separated from one another, transmitting the ion packets to a pusher electrode of the ToF mass analyzer, and periodically applying a voltage pulse to the pusher electrode of the ToF mass analyzer to direct ions received at the pusher electrode to a field free region of the mass analyzer. By way of example, and without limitation, the temporal width of the ion packets can be in a range of about 0.5 ms to about 50 ms. Further, the ratio of temporal spacing between successive ones of the ion packets relative to the temporal width of the ion packets can be, for example, in a range of about 2 to about 20.

In some such embodiments, a temporal width of the ion packets relative to a temporal spacing between the ion packets is selected so as to cause the ion beam intensity modulation at a detector disposed downstream of said ToF mass analyzer and configured to receive ions exiting the ToF mass analyzer.

In some embodiments, the bunching of the ions can be achieved by trapping ions associated with the ion beam in an ion trap, and periodically releasing at least a portion of the trapped ions and transmitting the released ions to a mass analyzer. By way of example, the trapped ions can be released from the ion trap at a frequency in a range of about 1 kHz to about 10 kHz, e.g., in a range of about 10 Hz to about 2000 Hz.

In some embodiments, the modulation of the ion beam intensity can be achieved by applying voltage pulses to an electrode positioned in the path of the ion beam and having an aperture through which the ions can pass. For example, the voltage pulses can be configured to periodically remove some ions from the ion beam so as to achieve modulation of the ion beam intensity. In some embodiments, the electrode can be positioned at a location along the ion path at which the ion beam is at least partially homogenized after ion removal. In other embodiments, the electrode can be positioned at a location along the ion path at which the ion beam is not homogenized after ion removal. Such homogenization can occur owing to collision with the bath gas or diffusion processes. Therefore, such parameters as ion guide pressure, length as well as electrical voltage propelling the ions through the ion guide may be selected for achieving appropriate level of ion beam homogenization. Since it can be beneficial operating the ion guide at the same pressure and generally length of an ion path cannot be freely controlled in the simplest ion guides, the position of ion modulation device as well as voltage propelling the ions can be appropriately selected instead.

In some embodiments, the modulation of the ion beam intensity can be achieved via varying the transmission coefficient of ions passing through at least one component of the mass spectrometer, e.g., an ion guide, a collision cell, etc.

In some embodiments, the modulation of the ion beam intensity can be achieved via periodic deflection of an ion beam relative to an ion-receiving aperture of a detector of a mass analyzer such that the ion flux (i.e., the number of ions per unit time) entering the detector can be varied.

In a related aspect, a method of operating a mass spectrometer is disclosed, which includes modulating an intensity of an ion beam to generate an intensity-modulated ion beam, acquiring a first set of one or more mass spectra during a first temporal segment of an ion intensity modulation cycle associated with said intensity-modulated ion beam, acquiring a second set of one or more mass spectra during a second temporal segment of the modulation cycle such that the ion intensity in at least a portion of said second temporal segment is less than the ion intensity in at least a portion of said first temporal segment, and utilizing said second set of mass spectra to interpret one or more coalesced mass peaks, if any, identified in said first set of mass spectra.

The two temporal segments can be disjoint or partially overlapping.

In a related aspect, a method of performing mass spectrometry is disclosed, which includes processing mass detections signals acquired during mass analysis of a sample to identify ion signal intensity modulation, if any, in the mass detection signals, processing the mass detection signals based on information regarding ion signal intensity modulation to generate two mass spectra corresponding to a lower and a higher ion signal intensity, and using the mass spectrum associated with the lower ion signal intensity to interpret one or more coalesced mass peaks, if any, identified in the mass spectrum corresponding to the higher ion signal intensity.

In a related aspect, a mass spectrometer is disclosed, which includes an ion source for ionizing at least one analyte in a sample, at least one ion guide for receiving the ions and generating an ion beam, means for modulating an intensity of said ion beam, a mass analyzer configured to generate mass detection data corresponding to at least two different intensities of the ion beam, and an analysis module configured to receive said mass detection data and process said mass detection data to generate two mass spectra each corresponding to one of said ion intensities, where the analysis module is further configured to compare the two mass spectra to interpret one or more coalesced mass peaks, if any, identified in the mass spectrum associated with the higher ion intensity.

In some embodiments, the means for modulating the intensity of the ion beam includes an ion trap for receiving the ion beam and a controller in communication with said ion trap and configured to periodically release ions from the ion trap so as to achieve a modulation of the ion beam intensity at an ion detector of said mass analyzer. By way of example, the ion trap can be a linear ion trap, a branched RF ion trap, among others.

In some embodiments, the means for modulating the ion beam intensity includes an electrode positioned in a path of said ion beam and having an aperture configured to allow passage of the ion beam therethrough, an adjustable DC voltage source configured to apply a DC voltage to said electrode, a controller in communication with said adjustable DC voltage source for modulating the DC voltage applied to said electrode so as to modulate passage of the ion beam through said electrode aperture.

In some embodiments, the means for modulating the ion beam intensity is configured to cause the ion beam intensity modulation without a substantial loss of ions in the beam. In other embodiments, the means for modulating the ion beam intensity is configured to cause periodic removal of ions from the ion beam so as to cause modulation of the ion beam intensity.

Further understanding of various aspects of the present teachings can be obtained by reference to the following detailed description in conjunction with the associated drawings, which are described briefly below.

### BRIEF DESCRIPTION OF THE DRAWINGS

FIG. 1A is a flow chart depicting various steps in an embodiment of a method according to the present teachings for performing mass spectrometry,

FIG. 1B is a flow chart depicting various steps in one implementation of the method of FIG. 1A for performing mass spectrometry,

FIG. 2A is a schematic view of a mass spectrometer according to an embodiment of the present teachings,

FIG. 2B is a schematic view of a mass spectrometer according to another embodiment of the present teachings,

FIG. 3A is a partial schematic view of a mass spectrometer in which modulation of an ion beam intensity is achieved according to an embodiment via application of a square-wave DC voltage to an ion lens positioned between an upstream Qjet and a downstream Q0 ion guide,

FIG. 3B is an example of an ion intensity modulation associated with an ion beam,

FIG. 3C is a partial schematic view of a mass spectrometer in which modulation of an ion beam intensity is achieved according to an embodiment via application of a square-wave DC voltage to an ion lens positioned between an ECD cell and a collision cell,

FIG. 3D is a flow chart depicting various steps in an embodiment of a method according to the present teachings in which collected mass data can be analyzed to identify natural ion signal intensity modulation, if any, that has occurred during data acquisition and use that information for interpretation of acquired mass spectra,

FIG. 4 schematically depicts an example of a modulated ion signal in which each data point is generated by applying a continuously changing ion transmission coefficient,

FIG. 5 schematically depicts an example of implementation of controller/analyzer suitable for use in the practice of the present teachings,

FIG. 6 shows modulation of an ion detection signal generated by an ion detector of a Tof mass analyzer in response to modulating the ion beam intensity as shown by the dashed curve (red), and

FIG. 7 shows histograms corresponding to (number of ion events)/(ADC response) ratios for mass spectra associated with tops, valleys and unpredictable, but detectable, short ion enhancement events with a high probability of coincidental ion arrivals known as “ion bombs,” respectively (the frequency sums to 1 under each trace).

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The phrase “coalesced mass peaks,” as used herein refers to a phenomenon where two closely-spaced mass peaks are co-detected as a single peak in the same detection event. The term “accurate” as used herein refers to a deviation of at most 5% from a true value.

The present disclosure relates to measuring an ion signal at two or more ion intensities, e.g., via modulation of the ion intensity, and utilizing the mass ion signals acquired at a lower ion intensity to interpret the mass ion signals acquired at a higher ion intensity. By way of example, a modulation of an ion beam during an accumulation time associated with an ion detector of a mass analyzer (e.g., a time-of-flight (ToF) mass analyzer) can be employed to cause a significant change in the rate of ion incidence on the ion detector. Since coalescence of mass peaks and ion signal saturation are more likely to occur at modulation peaks, rather than modulation valleys, the ion signals acquired during the modulation valleys can be utilized to glean information about the ion signals acquired during the mass peaks. That is, in many embodiments, low ion beam intensity detection pulses are utilized to interpret uncertain measurements (e.g., due to coalescence and/or signal saturation) that are associated with high ion beam intensity detection pulses. As discussed in more detail below, a variety of different ion intensity modulation patterns may be employed in the practice of the present teachings. By way of example, the ion intensity modulation pattern can be a uniform modulation, or a predefined pattern of frequency and attenuation, or it can be a data-driven pattern of ion intensity modulation for achieving an optimal ion detection sensitivity/specificity.

Various aspects of the present teachings are described in connection with a time-of-flight (ToF) mass analyzer. It should, however, be understood that the present teachings can be employed for analysis of ion detection signals generated in other types of mass analyzers employed in mass spectrometric systems, e.g., quadrupole mass analyzers.

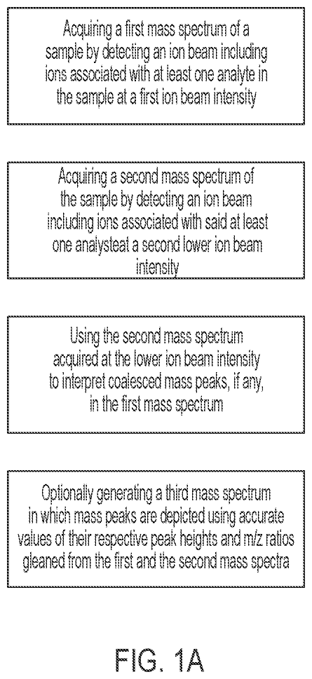

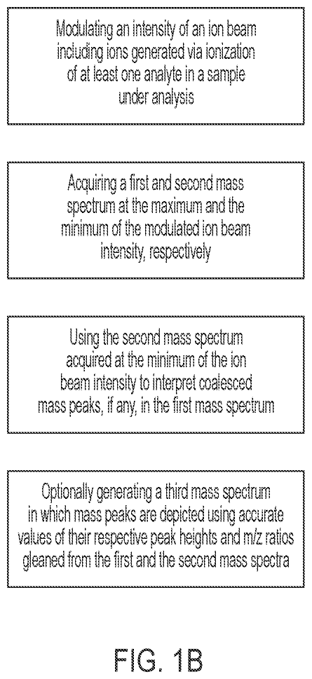

With reference to the flow chart of FIG. 1A, in one method according to an embodiment of the present teachings, a first ion detection signal can be acquired using an ion detector of a mass spectrometer in response to an ion beam incident on the ion detector at a first ion intensity and a second ion detection signal can be acquired at a second lower ion intensity. The first and the second ion detection signals can be utilized to generate a first mass spectrum corresponding to the first ion beam intensity and a second mass spectrum corresponding to the second ion beam intensity, respectively. The second mass spectrum can be used to interpret one or more coalesced mass peaks, if any, e.g., closely-spaced mass peaks corresponding to different isotopes, present in the first mass spectrum. The interpretation of the coalesced mass peaks can include deriving accurate mass peak heights and m/z ratios (e.g., via accurate determination of the centroid time) corresponding to those mass peaks.

With continued reference to the flow chart of FIG. 1A, in some embodiments, the first and the second mass spectra can be optionally used to generate a third mass spectrum (herein also referred to as a composite mass spectrum) in which all mass peaks, including the coalesced mass peaks in the first mass spectrum, are depicted with accurate peak heights and m/z values. In other words, the mass information contained in the first and the second mass spectra can be utilized to construct the composite mass spectrum.

With reference to the flow chart of FIG. 1B, in some embodiments, the intensity of an ion beam can be modulated and the first and the second mass spectra can be obtained at the maximum and the minimum of the modulated ion beam intensity, respectively. The second mass spectrum can be employed to interpret one or more coalesced mass peaks, if any, that are present in the first mass spectrum. For example, the second mass spectrum can be utilized to derive accurate peak heights and m/z ratios associated with the coalesced mass peaks.

The depth of the ion beam intensity modulation (i.e., the ratio of the maximum to minimum ion beam intensity) can be selected based on a particular application. By of way of example, in some embodiments, the modulation depth of the intensity modulation can be in a range of about 2 to about 20 ion counts per second.

In some embodiments, the modulation of the ion beam intensity can be achieved without a substantial loss of ions in the ion beam, e.g., by causing periodic bunching of the ions. In other embodiments, the modulation of the ion beam intensity can be achieved via periodic removal of ions from the beam, which results in a lossy modulation.

By way of example, in some embodiments, the ions in the ion beam can be modulated so as to generate a plurality of ion packets. Further, the temporal widths of the ion packets and the temporal spacing between successive ion packets can be selected so as to generate an ion beam intensity modulation on a downstream detector, e.g., a detector of a downstream mass analyzer, on which the ions are incident. As noted above, in some embodiments, the temporal width of the ion packets can be in a range of about 0.5 ms to about 50 ms, e.g., in a range of about 10 ms to about 30 ms. Further, the temporal spacing between the successive ion packets relative to the temporal width of the ion packets can be in a range of about 2 to about 20.

In other embodiments, the modulation of the ion beam intensity can lead to a periodic loss of some of the ions from the ion beam, thereby resulting in the modulation of the ion beam intensity. By way of example, in some such embodiments, a voltage applied to an electrode having an opening through which the ions pass can be modulated to periodically remove some of the ions from the ion beam, thereby imparting an intensity modulation to the ion beam.

In general, the modulation of the ion beam intensity is configured so as to reduce the probability of ion coalescence at the minimum of the ion intensity modulation. In embodiments, this allows the generation of a mass spectrum in which mass peaks corresponding to analytes having close m/z ratios (which could otherwise lead to coalesced mass peaks at higher ion beam intensities) are resolved. The resolution of such mass peaks at lower ion intensity levels can in turn allow accurate determination of their peak heights and m/z ratios (peak centroid locations). Such information can be utilized, together with the mass information gleaned from the high-intensity and the low-intensity mass spectra, to construct a third mass spectrum in which all mass peaks, including those that appear as coalesced mass peaks in the high-intensity mass spectrum, are accurately presented. That is, all mass peaks are presented in the third mass spectrum with accurate peak heights and m/z ratios.

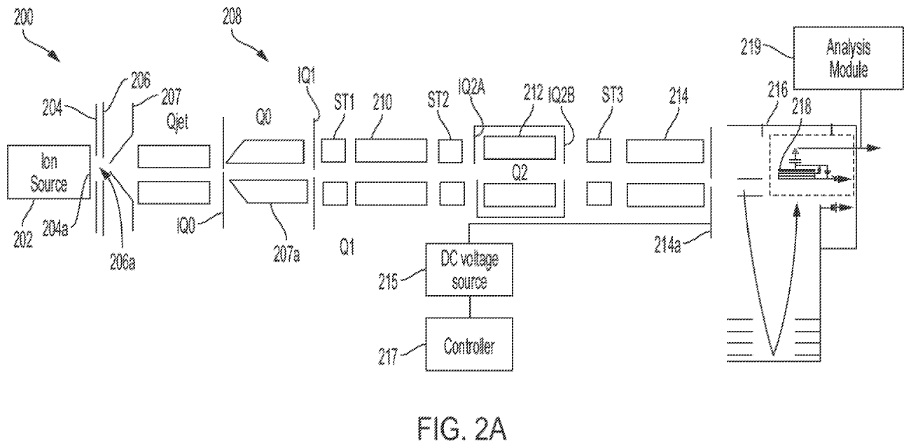

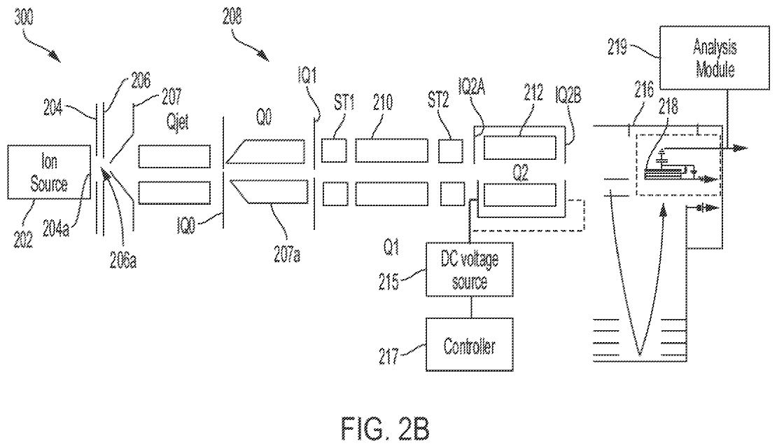

FIG. 2A schematically depicts a mass spectrometer 200 which includes an ion source 202 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions pass through an orifice 204a of a curtain plate 204 and an orifice 206a of an orifice plate 206, which is positioned downstream of the curtain plate and is separated from the curtain plate such that a gas curtain chamber is formed between the orifice and the curtain plate. A curtain gas supply (not shown) can provide a curtain gas flow (e.g., of N₂) between the curtain plate 204 and the orifice plate 206 to help keep the downstream sections of the mass spectrometer clean by declustering and evacuating large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions then pass through an orifice 207a of a skimmer 207 to be received by an ion optic Qjet, which includes four rods (two of which are shown in the figure) arranged in a quadrupole configuration to which RF voltages can be applied to generate a quadrupolar electromagnetic field in the space between the rods. The Qjet optic can capture and focus the ions using a combination of gas dynamics and radio frequency fields.

The ions are then transmitted via an ion lens IQ0 into an ion guide Q0, which comprises four rods 208 (two of which are visible in this figure) that are arranged in a quadrupole configuration to form an ion beam for transmission to downstream components of the mass spectrometer.

The ion beam exits the Q0 ion guide and is focused via an ion lens IQ1 and a stubby lens ST1 into a subsequent ion mass analyzer Q1, which includes four rods 210 (two of which are visible in this figure) that are arranged in a quadrupole configuration and to which RF voltages as well as a DC resolving voltage can be applied for radially focusing the ions and selecting ions having a target m/z ratio (herein referred to as precursor ions) as they pass through the Q1 mass analyzer. In other embodiments, other multipole configurations, such as a hexapole or an octupole configuration, can be utilized.

More specifically, in this embodiment, the quadrupole rod set Q1 can be operated as a conventional transmission RF/DC quadrupole mass filter for selecting ions having an m/z value of interest or m/z values within a range of interest. By way of example, the quadrupole rod set Q1 can be provided with RF/DC voltages suitable for operation in a mass-resolving mode. For example, parameters of the applied RF and DC voltages can be selected so that Q1 establishes a transmission window of chosen m/z ratios, such that these ions can traverse Q1 largely unperturbed. Ions having m/z ratios falling outside the window, however, do not attain stable ion trajectories within the quadrupole and can be prevented from traversing the quadrupole rod set Q1. It should be appreciated that this mode of operation is but one possible mode of operation for Q1.

The ions passing through the Q1 mass analyzer are focused via a stubby lens ST2 and an ion lens IQ2A into a collision cell Q2. The collision cell Q2 includes four rods 212 (two of which are visible in this figure) that are arranged in a quadrupole configuration and to which RF voltages can be applied for providing radial confinement of the ions. The rods 212 are disposed within an enclosure 213 such that the pressure within the collision cell can be increased relative to the other stages, e.g., via introduction of a gas (e.g., nitrogen) into the enclosure. While in some embodiments, the collision cell Q2 is employed to cause fragmentation of the ions received by the collision cell, in other embodiments, the collision cell Q2 is not utilized for ion fragmentation, but rather for causing, for example, collisional cooling of the ions.

The ions passing through the collision cell are guided via an ion lens IQ2B to an ion trap 214 and are released periodically from the ion trap as a plurality of ion packets with the temporal widths of the ion packets and the temporal spacing between the adjacent ion packets configured so as to cause a modulation of the ion beam intensity of the ions arriving at a downstream ion detector after passage through a ToF mass analyzer.

More specifically, in this embodiment, a DC voltage source 215 can apply a DC barrier voltage to an exit electrode 214a disposed in proximity of the exit end of the ion trap 214, and a controller 217 in communication with the DC voltage source 215 can modulate the DC barrier voltage to cause the release of ions from the ion trap in a manner that would lead to a modulation of the ion beam intensity at the downstream ion detector.

The ions exiting the ion trap reach a downstream time-of-flight (ToF) mass analyzer 216 and are separated by the ToF mass analyzer based on their mass-to-charge ratios (m/z) and detected via an ion detector 218 associated with the ToF mass analyzer.

An analysis module 219 is in communication with the ion detector 218 to receive ion detection signals (e.g., electrical pulses) generated by the ion detector 218 and to process those signals to generate a mass spectrum of the detected ions. The analysis module 219 can also be configured to analyze the high-intensity mass spectra and the low-intensity mass spectra in accordance with the present teachings to interpret coalesced mass peaks, if any, present in the high-intensity mass spectra. Further, the analysis module 219 can be configured to employ the information gleaned from the low-intensity mass spectra with regard to the accurate values of peak heights and m/z ratios of the coalesced mass peaks to generate a third mass spectrum in which all mass peaks, including the coalesced mass peaks, are presented with their accurate peak heights and associated m/z ratios (i.e., the centroid of the mass peaks).

In this embodiment, the modulation of the ion beam's intensity is achieved without any substantial loss of the ions from the ion beam.

In other embodiments, the modulation of the ion beam's intensity may be achieved via removal of ions from an ion beam. By of example, FIG. 2B schematically depicts a mass spectrometer 300, which is similar to the mass spectrometer 100 discussed above in connection with FIG. 2B (identical reference numerals are employed to illustrate identical components), except that the mass spectrometer 300 does not include an ion trap. Further, in the mass spectrometer 300, the DC voltage source 215 applies a modulated DC voltage to the inlet IQ2A or the outlet IQ2B lens of the collision cell Q2 to cause a modulation of the ion beam's intensity by periodically removing some of the ions from entering the collision cell or periodically removing some of the ions exiting the collision cell. In other words, the modulation of the ion beam's intensity in this embodiment is achieved via periodic loss of certain ions from the beam. The ions exiting the collision cell are received by the ToF mass analyzer 216.

Again, similar to the previous embodiment, the analysis module 219 can receive the ion detection signals generated by the ion detector 218 of the ToF mass analyzer 216 and can process those signals to generate mass spectra corresponding to two different ion beam intensities, e.g., the maximum and minimum of the ion intensity modulation. Further, the analysis module 219 can interpret any coalesced mass peaks present in a high intensity mass spectrum (e.g., a mass spectrum acquired at the maximum of the ion beam's intensity) via information gleaned from a respective low-intensity mass spectrum (e.g., a mass spectrum acquired at the minimum of the ion beam's intensity), in a manner disclosed herein.

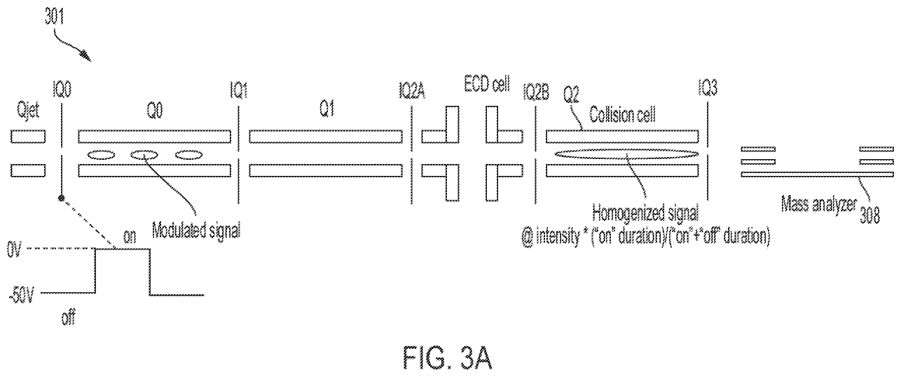

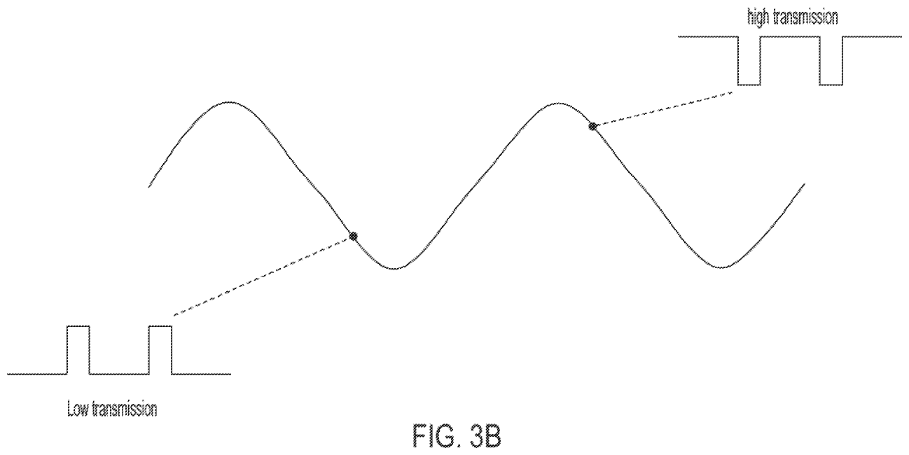

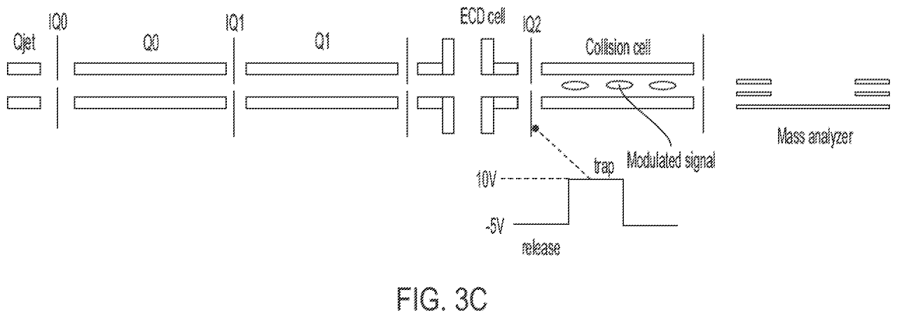

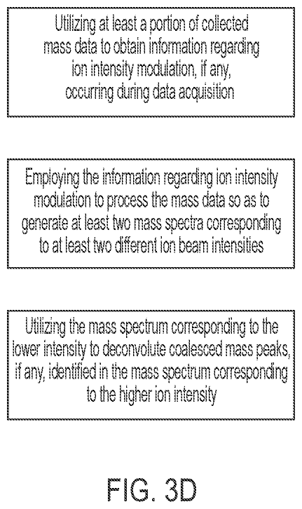

FIG. 3A schematically depicts that the modulation of an ion beam can be achieved by modulating the entry of the ion beam into an ion guide. More specifically, FIG. 3A is a partial schematic view of a mass spectrometer 301 according to an embodiment, which includes a Qjet ion guide that focuses ions received from an upstream ion source (e.g., an atmospheric ionization source) into an ion beam. The ion beam is then focused by an ion lens IQ0 into a downstream ion guide Q0.

The mass spectrometer can be operated between a first ion beam intensity and a second lower ion beam intensity. For example, in order to lower the ion intensity beam intensity, a voltage source (not shown in the figure) can apply a square-wave voltage to the ion lens IQ0 to modulate transfer of the ion beam from the Qjet into the Q0 ion guide. More specifically, in this embodiment, the square-shaped voltage offset applied to the ion lens IQ0 varies between zero and-50 V relative to Q0, where at zero voltage the ion beam passes uninhibited from the Qjet ion guide into the Q0 ion guide and at −50 V, the ion beam is prevented from entry into the Q0 ion guide. This periodic modulation of the ion beam entry into the Q0 ion guide results in the generation of a plurality of temporally separated ion packets 302, which are received by a downstream mass filter Q1, via passage through an ion lens IQ1, which can be configured to select precursor ions having a desired m/z ratio or transmit all received ions downstream

The ions passing through the collision cell Q2 are received by a mass analyzer 308, which can generate a mass spectrum of the product ions.

FIG. 3B schematically shows that the ion beam intensity can be modulated by employing a continuously changing ion transmission coefficient. While the ion beam can be fully homogenized with a single ion transmission coefficient, the continuous change can enable modulation.

FIG. 3C schematically depicts an embodiment in which the intensity of an ion beam can be controlled via application of a square-wave gating voltage to the IQ2 lens that is positioned between the ECD cell and the collision cell Q2 to generate a plurality of temporally separated ion packets that pass through the collision cell Q2 to reach the mass analyzer 306. In this embodiment, the ion beam that is modulated at the IQ2 lens is not fully homogenized when reaching the mass analyzer 308, thereby resulting in modulation of the ion beam intensity.

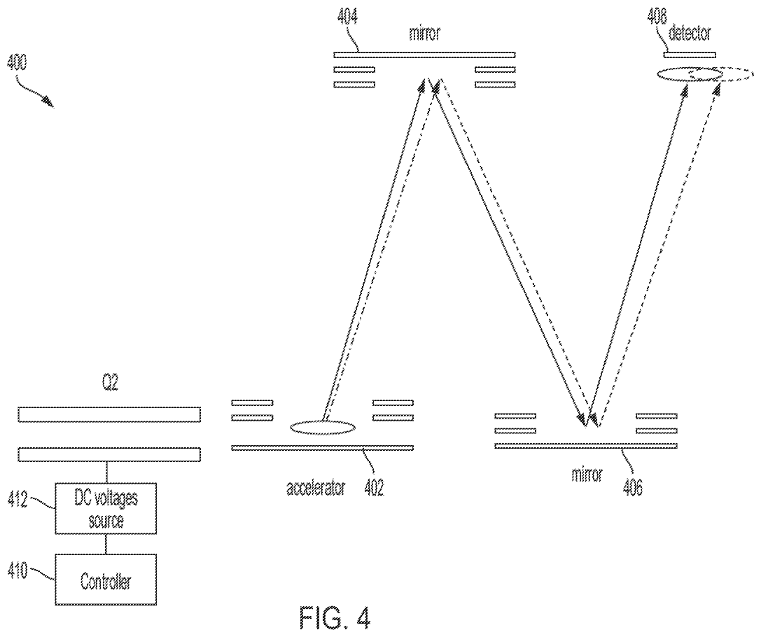

FIG. 4 schematically depicts another example of modulating the intensity of an ion beam in a mass spectrometer according to the present teachings. More specifically, FIG. 4 is a partial schematic view of a mass spectrometer 400 according to such an embodiment in which ions exiting a collision cell Q2 are received by an accelerator 402, which directs the received ions to a first ion mirror 404. The ion mirror 404, in turn, reflects the ions toward a second ion mirror 406, which reflects the ions onto a detector 408 of a downstream mass analyzer. The ion intensity at the detector can be modulated by adjusting a relative potential applied between the Q2 collision cell and the accelerator. For example, the relative potential between the Q2 collision cell and the accelerator 402 can be periodically varied between two values (or be varied continuously between two values) so as to cause periodic deflection of the ion beam over the ion detector, thereby causing variation of the intensity of the ion beam incident on the ion detector.

By way of illustration, in this embodiment, a controller 410 can control a voltage source 412, which applies a DC voltage to a plurality of rods of the Q2 collision cell so as to vary the applied voltage and hence modulate the DC potential between the Q2 collision cell and the accelerator 402.

In a related aspect, the present teachings can be employed to address mass peak coalescence that can occur in mass spectra acquired in a Fourier Transform mass spectrometer using an image charge detector. An image charge detector of a mass analyzer measures a time-varying current or voltage induced on a detector of the mass analyzer by nearby oscillations of ions in the mass analyzer to generate a transient time domain signal. The induced transient time domain signal measured by the ion charge detector includes components from each of the ions oscillating in the mass analyzer. In order to decompose the transient time-domain signal into individual components, the signal is converted into a frequency-domain signal. By way of example and without limitation, such conversion of the time-domain signal to a frequency-domain signal can be achieved via application of Fourier transformation or wavelet transformation to the time-domain signal.

The mass frequency-domain signal acquired via conversion of the time-domain signal to the frequency domain can be treated in accordance with the present teachings in the same manner as, for example, the application of the present teachings to voltage pulses generated by an ion detector of a ToF mass analyzer. More particularly, the frequency domain signal obtained at two different ion beam intensities can be compared with one another to interpret one or more coalesced mass peaks, if any, present in the frequency domain signal associated with the higher intensity ion beam. Optionally, the information gleaned from the two mass spectra can be utilized to generate a third mass spectrum (herein also referred to as a composite mass spectrum) in which all mass peaks including those that appear as coalesced mass peaks in the high-intensity mass spectrum are presented with accurate mass peak heights and m/z ratios. Since FT instruments often require much longer acquisition times, the modulation period can be matched with the acquisition period. In addition, usually for ion introduction into FT MS analyzer the ions are pretrapped and conditioned. Therefore, the number of ions injected at each cycle can be alternated between two or more discrete quantities and in such manner the modulation can be achieved.

In some cases, a modulation of ion signal intensity may occur not as a result of actively imposing an intensity modulation on an ion beam, e.g., in a manner discussed above, but rather as a result of data acquisition and ion signal detection schemes employed in a mass spectrometer. Such ion intensity modulations are herein referred to as “natural ion signal intensity modulation.” In some embodiments, a natural ion signal intensity modulation can be identified during post-processing of the mass data and can be utilized to interpret coalesced mass peaks, if any, detected in a mass spectrum. For example, with reference to the flow chart of FIG. 3D, in some such embodiments, at least a portion of collected mass data can be processed to obtain information regarding the intensity associated with each ion detection signal (e.g., a voltage pulse) generated by the ion detector in response to incidence of ions thereon. Such information can allow generating a temporal variation of ion signal intensity during data acquisition. The information regarding the natural ion signal intensity modulation can then be used to process the mass data so as to generate at least two mass spectra at two different ion signal intensities. For example, the information regarding the ion signal intensity modulation can be used to identify the mass data corresponding to the peaks and valleys of the modulated ion signal intensity. The mass data corresponding to the peaks of the ion signal intensity modulation can then be processed in a manner known in the art (e.g., by binning the data according to the m/z ratios of the detected ions) to generate a mass spectrum corresponding to the modulation peaks and the mass data corresponding to the valleys of the ion signal intensity modulation can be processed to generate a mass spectrum corresponding to the valleys. The mass spectrum corresponding to the valleys of the ion intensity modulation can then be utilized in a manner discussed herein to achieve deconvolution of one or more coalesced mass peaks, if any, identified in the mass spectrum corresponding to the peaks of the ion intensity modulation.

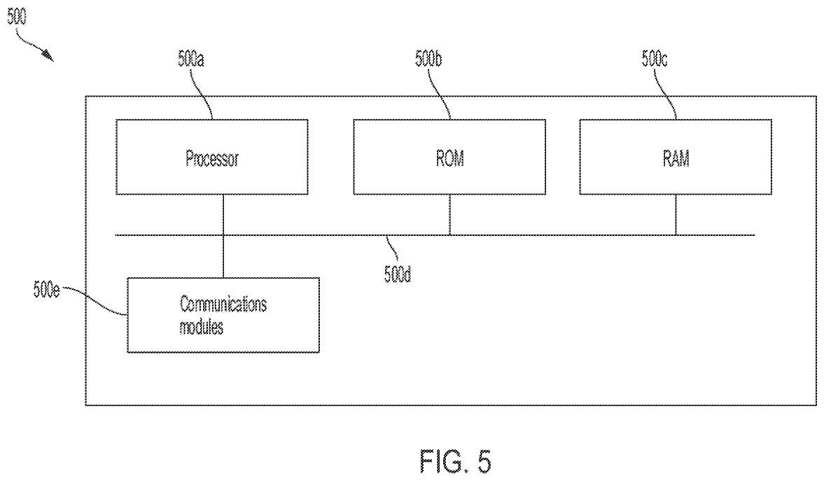

As noted above, a controller and an analysis module suitable for use in the practice of the present teachings, such as the above controller 217 and the analysis module 219 can be implemented in hardware, firmware and/or software in a manner known in the art as informed by the present teachings. By way of example, FIG. 5 schematically depicts an example of such an implementation of the analysis module 219.

FIG. 5 schematically depicts an example of an implementation of such a controller 500, which includes a processor 500a (e.g., a microprocessor), at least one permanent memory module 500b (e.g., ROM), at least one transient memory module (e.g., RAM) 500c, and a communication bus 500d, among other elements generally known in the art.

The communication bus 500d allows communication between the processor and various other components of the controller. In this example, the controller 500 can further include a communications module 500e that is configured to allow sending and receiving signals.

Instructions for use by the controller 500, e.g., for modulating a DC voltage applied to an electrode as discussed above for modulating the ion beam's intensity or modulating the relative potential between the collision cell Q2 and the accelerator 402 discussed in connection with the embodiment of FIG. 4, can be stored in the permanent memory module 500b and can be transferred into the transient memory module 500c during runtime for execution. The controller 500 can also be configured to control the operation of other components of the mass spectrometer, such as the ion guide, and mass analyzer, among others.

### Example

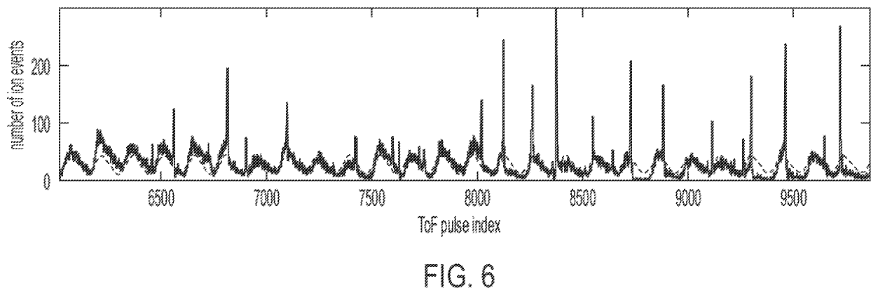

A Sciex Zeno ToF 7600 time-of-flight (ToF) mass spectrometer was employed to obtain the data shown in FIG. 6. A Sciex calibration mixture was used for acquisition of the illustrated data. Ions were trapped in an EAD (electron activated dissociation) cell and were released with a total cycle time of 667 microseconds. For this, a DC voltage applied to an electrode (IQ2A) positioned in proximity of an inlet of the EAD cell was employed to ensure that the electrode was always open (i.e., it would allow the passage of ions through an opening thereof) in the direction towards a mass analyzer positioned downstream of the EAD cell and was closed (i.e., it would not allow the passage of ions) in the reverse direction, while a DC voltage applied to an electrode (IQ2B) positioned in proximity of the outlet of the EAD was modulated to ensure that the electrode was open half of the time (i.e., it would allow the release of ions from the ion trap) and closed half of the time, thus facilitating ion trapping in EAD cell.

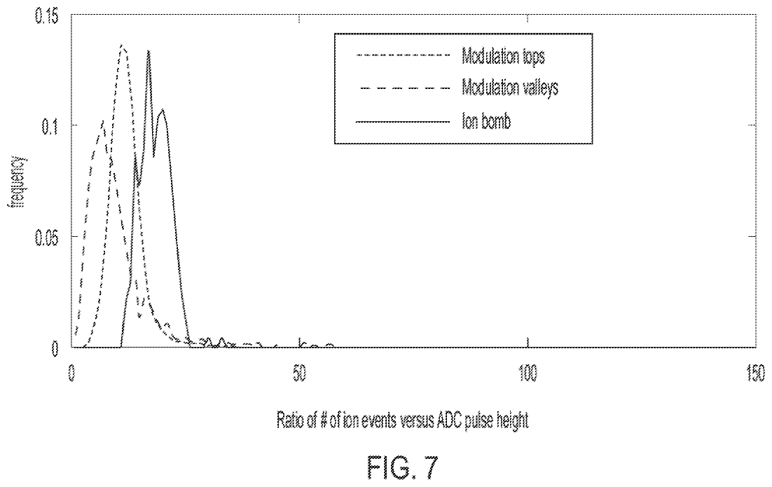

By way of further illustration, FIG. 7 shows histograms of (number of ion events)/(ADC response) ratios for mass spectra corresponding to modulation tops, valleys and “ion bombs,” respectively. Ion coincidence likelihood can be inferred from the ratio of the number of ion events and cumulative ADC responses for a spectrum. If the ratio distribution would resemble a signal ion ADC response distribution, then it can be inferred that ion events are most likely signal ion hits, as shown by the trace labeled as “modulation vallyes,” In contrast, the traces labeled as “modulation tops” and “ion bombs” correspond clearly to spectra with a high frequency of coincidental ion arrivals.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill in the art will appreciate that various changes can be made to the above embodiments without departing from the scope of the invention.

What is claimed is:

1. A method of operating a mass spectrometer, comprising:
acquiring a first mass spectrum of a plurality of ions at a first ion beam intensity,
acquiring a second mass spectrum of said plurality of ions at a second ion beam intensity lower than the first ion beam intensity, and
using the second mass spectrum to interpret at least one mass peak comprising two or more coalesced mass peaks, if any, in the first mass spectrum.

2. The method of claim 1, wherein the step of interpreting the at least one mass peak comprises determining a peak intensity and an m/z ratio associated with each of said two or more coalesced mass peaks.

3. The method of claim 2, further comprising generating a third mass spectrum in which each of the coalesced mass peaks is identified based on the peak intensity and the m/z ratio determined for that coalesced mass peak using the second mass spectrum.

4. The method of claim 1, further comprising modulating an intensity of the ion beam to generate an intensity-modulated ion beam such that said first and said second ion beam intensities correspond to different ion beam intensities during a cycle of the ion beam intensity modulation, and wherein optionally one of said two different ion beam intensities corresponds to a maximum of the ion beam intensity modulation and the other one of said two different ion beam intensities corresponds to a minimum of the ion beam intensity modulation.

5. The method of claim 4, wherein a ratio of the maximum intensity of the intensity modulated ion beam relative to the minimum intensity thereof is in a range of about 2 to about 20.

6. The method of claim 1, wherein said second lower ion beam intensity is selected so as to reduce probability of ion coalescence.

7. The method of claim 1, wherein said two or more coalesced mass peaks correspond to mass peaks associated with two or more different isotopes of an analyte.

8. The method of claim 1, wherein said first and second mass spectra are acquired using a time-of-flight (Tof) mass analyzer.

9. The method of claim 4, wherein said ion beam modulation is performed without a substantial loss of ions.

10. The method of claim 4, wherein said step of modulating the intensity of the ion beam comprises:
bunching ions in the ion beam to generate a plurality of ion packets temporally separated from one another,
transmitting said ion packets to a pusher electrode of the ToF mass analyzer, and
periodically applying a voltage pulse to the pusher electrode of the ToF mass analyzer to direct ions received at the pusher electrode to a field free region of the mass analyzer.

11. The method of claim 10, wherein a temporal width of the ion packets relative to a temporal spacing between the ion packets is selected so as to cause the ion beam intensity modulation at a detector disposed downstream of said ToF mass analyzer and configured to receive ions exiting the ToF mass analyzer, and wherein, optionally, the temporal width of the ion packets is in a range of about 0.5 ms to about 50 ms.

12. The method of claim 11, wherein a ratio of temporal spacing between successive ones of the ion packets relative to said temporal width of the ion packets is in a range of about 2 to about 20.

13. The method of claim 10, wherein the step of bunching the ions comprises:
trapping ions associated with the ion beam in an ion trap, and
periodically releasing at least a portion of the trapped ions and transmitting the released ions to mass analyzer.

14. The method of claim 13, wherein the ions are released from the ion trap at a frequency in a range of about 1 kHz to about 20 kHz.

15. The method of claim 4, wherein said step of modulating the intensity of the ion beam comprises applying voltage pulses to an electrode positioned in a path of the ion beam having an aperture through which the ions can pass.

16. The method of claim 15, wherein the voltage pulses are configured to periodically remove some ions from the ion beam to achieve the intensity modulation of the ion beam.

17. The method of claim 15, wherein said electrode is positioned in a path of the ion beam at a location at which the ion beam is at least partially homogenized or at a location at which the ion beam is not homogenized.

18. A mass spectrometer, comprising:
an ion source for ionizing at least one analyte in a sample,
at least one ion guide for receiving the ions and generating an ion beam,
means for modulating an intensity of said ion beam,
a mass analyzer configured to generate mass detection data corresponding to at least two different intensities of the ion beam, and
an analysis module configured to receive said mass detection data and process said mass detection data to generate two mass spectra each corresponding to one of said ion intensities,
wherein the analysis module is further configured to compare the two mass spectra to interpret one or more coalesced mass peaks, if any, identified in the mass spectrum associated with the higher ion intensity.

19. The mass spectrometer of claim 18, wherein said means for
modulating the intensity of the ion beam comprises:
an ion trap for receiving said ion beam, and
a controller in communication with said ion trap and configured to periodically release ions from the ion trap so as to achieve a modulation of the ion beam intensity at an ion detector of said mass analyzer.

20. The mass spectrometer of claim 18, wherein said means for
modulating the ion intensity comprises:
an electrode positioned in a path of said ion beam and having an aperture configured to allow passage of the ion beam therethrough,
an adjustable DC voltage source configured to apply a DC voltage to said electrode, and
a controller in communication with said adjustable DC voltage source for modulating the DC voltage applied to said electrode so as to modulate passage of the ion beam through said electrode aperture.
